(19) United States
(12) Patent Application Publication
(10) Pub. No.: US 2010/0129169 A1
(43) Pub. Date: May 27, 2010

(54) Corner Portion Working Tool

(75) Inventors: Masayuki Kyoi, Yokohama (JP); Hideaki Onozuka, Sagamihara (JP); Koji Utsumi, Hitachi (JP); Ippei Kono, Fujisawa (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/625,149

(22) Filed: Nov. 24, 2009

(30) Foreign Application Priority Data
Nov. 26, 2008 (JP) 2008-301152
Apr. 23, 2009 (JP) 2009-105402

(51) Int. Cl. B23B 51/08

(52) U.S. Cl. 408/26; 408/22; 407/53

(57) ABSTRACT

A corner portion working tool includes: a main body portion 4 having a space 5 through which a cutting fluid can pass; and a blade portion 8 that is provided in the main body portion 4 and can be displaced outwardly of the main body portion 4, wherein the blade portion 8 is displaced outwardly of the main body portion 4 according to a change in hydrostatic pressure of the cutting fluid having passed through the space 5, and the main body portion 4 is rotated to work a corner portion with the blade portion 8. Thus, the corner portion working tool brings the blade portion for deburring or corner portion shape forming into contact with only a hole end surface, does not reduce quality of an inner wall surface of a hole, does not select a proper rotation condition, and easily performs deburring or corner portion shape forming.

The present application is based on and claims priorities of Japanese patent applications No. 2008-301152 filed on Nov. 26, 2008 and No. 2009-105402 filed on Apr. 23, 2009, the entire contents of which are hereby incorporated by reference.

### BACKGROUND OF THE INVENTION

1. Field of the Invention

The present invention relates to a corner portion working tool, and more particularly to a corner portion working tool for working a corner portion in forming a through hole or a groove in a machine element component.

2. Description of the Related Art

A machine element component includes a component having a hole shape such as a through hole or a crossing hole, or a component having a groove parallel to an axis in an outer peripheral portion such as a spline shaft or a slide shaft. In a step of machining the hole shape or the groove with a drilling tool or by turning, a burr is formed at a corner portion of a working inlet and outlet by a drilling tool or a turning tool.

FIGS. 1A to 1C show a formation state of a burr formed by such working, FIG. 1A shows a typical formation state of a burr in a case where crossing holes perpendicularly cross each other, FIG. 1B shows a typical formation state of a burr in a case where crossing holes diagonally cross each other, and FIG. 1C shows a typical formation state of a burr in a case where a groove parallel to an axis is formed.

As shown in FIG. 1A, when a first hole is horizontally formed by a drilling tool, and then a second hole is formed crossing the first hole perpendicularly to an axial direction in a material for forming the machine element component, a downward burr is formed along an outer periphery of the second hole at a crossing portion.

Also, as shown in FIG. 1B, when a first hole is formed diagonally to an axial direction, and then a second hole is formed perpendicularly to the axial direction, a downward burr is formed along an outer periphery of the second hole particularly at a portion where the second hole crosses the first hole at an acute angle.

Further, as shown in FIG. 1C, when a groove parallel to an axis is formed by a turning tool, a burr is formed particularly in a direction of the turning tool being removed from the groove.

When such a burr remains, fatal trouble may be caused particularly in a hydraulic or pneumatic apparatus, and thus the burr at the corner portion needs to be optimally removed depending on burr formation states in view of performance of the machine element. When the corner portion after the removal of the burr has too sharp a shape, stress is concentrated on the corner portion, and the corner portion seriously wears and may chip and fall during use of the machine element. This is a fatal defect particularly in a mechanism component or the like whose relative position needs to be determined by a round pin and a hole portion, and thus an optimum corner portion shape needs to be formed at each corner portion to relieve stress concentration.

Deburring and corner portion shape forming after the hole shape is formed are most generally performed manually by an automatic file tool using rotational movement or sliding movement of a pneumatic motor or an electric motor. However, with this method, an amount of deburring and an amount of corner portion forming are unstable because of a manual operation and it takes a long operation time. Also, for example, when a diameter of the hole is about 10 mm or less and a depth is larger than the diameter, a working surface of the file tool cannot be placed on a tool outlet of the worked hole, and deburring and corner portion shape forming at the tool outlet cannot be performed in some cases. Further, when the diameter of the hole is large but the hole is deep, there is a possibility that the tool cannot be placed and thus the corner portion cannot be worked.

For automatic deburring on a tool outlet side, for example, there is a method in which a drilling tool having a blade portion that can be moved in an outer peripheral direction by a spring mechanism is mounted to a spindle of an NC machining device to remove a burr at a worked hole outlet as disclosed in Japanese Patent Laid-Open Publication No. 2003-145331 (Patent Document 1).

As a method without a mechanical mechanism such as a spring, there is a method in which a brush tool is mounted to a spindle of an NC machining device, and the tool is rotated and inserted into a hole to remove a burr as described in ILLUSTRATED DEBURRING TECHNIQUE FOR AUTOMATION, edited by cutting fluid technique research group, p. 46, Kogyo Chosakai (Non-Patent Document 1). Also, there is a method in which a grindstone tool is mounted to a spindle of an NC machining device, and the tool is moved along an end surface of a hole to perform deburring and corner portion forming.

However, the tool as disclosed in Japanese Patent Laid-Open Publication No. 2003-145331 (Patent Document 1) has a blade portion that can be moved in an outer peripheral direction by a spring mechanism, and thus a part of the blade portion comes into contact with an inner wall surface of a worked hole, which may reduce quality of the hole. Also, when the brush tool is used as described in ILLUSTRATED DEBURRING TECHNIQUE FOR AUTOMATION, edited by cutting fluid technique research group, p. 46, Kogyo Chosakai (Non-Patent Document 1), the brush also comes into contact with a hole inner wall where a burr is not formed, which may still reduce quality of the hole. When the grindstone tool is used, an amount of deburring and a corner portion shape are sometimes unstable due to wear of the grindstone and hole position accuracy. Also, in the conventional techniques, it takes time to set a proper rotation condition of the tool for automatically forming a corner portion shape after removal of the burr.

Further, it is difficult to efficiently perform deburring and corner portion forming depending on various burr formation states as shown in FIGS. 1A to 1C.

Thus, the present invention has an object to provide a corner portion working tool that brings a blade portion for deburring or corner portion shape forming into contact with only a hole end surface, does not reduce quality of an inner wall surface of a hole, does not require considering a proper rotation condition, and at that time, causes a machining device such as an NC device to be able to select a blade portion having an optimum shape depending on various burr formation states according to aspects of working, and thus automatically and easily performs deburring or corner portion shape forming.

### SUMMARY OF THE INVENTION

To achieve the above-described object, the present invention provides a corner portion working tool including: a main body portion having a space through which a cutting fluid can pass; and a blade portion that is provided in the main body portion and can be displaced outwardly of the main body portion, wherein the blade portion is displaced outwardly of the main body portion according to a change in hydrostatic pressure of the cutting fluid having passed through the space, and the main body portion is rotated to work a corner portion with the blade portion.

Further, in the corner portion working tool of the present invention, the blade portion is mounted to the main body portion via an elastic member, and with increasing hydrostatic pressure of the cutting fluid, the blade portion is displaced outwardly of the main body portion against an elastic force of the elastic member.

At this time, a relationship between hydrostatic pressure of the cutting fluid and an amount of outward displacement of the blade portion is previously calculated by experiment for each type of corner portion working tool, and the selected hydrostatic pressure of the cutting fluid is supplied to the space in the main body portion so as to obtain a necessary amount of outward displacement in working the corner portion.

Also, in the corner portion working tool, a cutting blade of the blade portion is perpendicular to a rotational direction, has a surface with a side inclined to an axial direction on an outer peripheral side, and the cutting blade works the corner portion.

Further, in the corner portion working tool, the cutting blade of the blade portion is at an obtuse angle to the rotational direction, has a rake angle of −45° to a cutting direction, and has a curved surface with a relief angle of +45° or more, and the cutting blade works the corner portion.

According to the present invention, the above-described tool is used to use spindle rotation of a machining device such as an NC working device, and this does not require an operator for deburring or corner portion forming. Also, an amount of diameter change of the blade portion relating to deburring or corner portion shape forming of the tool can be determined without depending on a rotational speed of the spindle of the machining device, an amount of shape forming can be determined by supply pressure of the cutting fluid, and thus there is no need to previously consider a proper rotational speed of the spindle. An amount of blade edge displacement can be determined by the supply pressure of the cutting fluid, and thus there is no need to move the tool along an end surface of a tool hole, which can reduce a working time.

At this time, a tool having a cutting blade of a blade portion that is perpendicular to a rotational direction and has a surface with a side inclined to an axial direction on an outer peripheral side, or a blade portion that is at an obtuse angle to the rotational direction, has a rake angle of −45° to a cutting direction, and has a curved surface with a relief angle of +45° or more is selected to allow optimum deburring and corner portion forming depending on various burr formation states.

### BRIEF DESCRIPTION OF THE DRAWINGS

FIG. 1A shows a typical formation state of a burr in a case where crossing holes perpendicularly cross each other;

FIG. 1B shows a typical formation state of a burr in a case where crossing holes diagonally cross each other;

FIG. 1C shows a typical formation state of a burr in a case where a groove parallel to an axis is formed;

FIG. 2A is an element sectional view showing a tool and a deburring state for illustrating working with a corner portion working tool of Embodiment 1, and shows a state before working;

FIG. 2B is an element sectional view showing the tool and the deburring state for illustrating working with the corner portion working tool of Embodiment 1, and shows a state during working;

FIG. 3A is an element sectional view showing a tip of the tool of Embodiment 1 shown in FIG. 2;

FIG. 3B is an element sectional view of a part C in the element sectional view in FIG. 3A viewed from an upper side in an axial direction;

FIG. 4 is a graph showing a relationship between cutting fluid supply pressure for moving a blade portion of the tool of Embodiment 1 shown in FIGS. 2A, 2B, 3A and 3B and an amount of movement;

FIG. 5 is an element sectional view for illustrating a relative position between an amount of movement of the tool blade portion of the tool of Embodiment 1 shown in FIGS. 2A, 2B, 3A and 3B and a component;

FIG. 6A is an element sectional view showing a tool and a deburring state for illustrating working with a corner portion working tool of Embodiment 2, and shows a state before working;

FIG. 6B is an element sectional view showing the tool and the deburring state for illustrating working with the corner portion working tool of Embodiment 2, and shows a state during working;

FIG. 7 is an element sectional view showing a tool and a deburring state for illustrating working with a corner portion working tool of Embodiment 3;

FIG. 8A is an element overview diagram showing the tool and a state of the tool blade portion for deburring for illustrating working with the corner portion working tool of Embodiment 1, and a perspective view of the tool blade portion in Embodiment 1;

FIG. 8B is an element overview diagram showing the tool and the state of the tool blade portion for deburring for illustrating working with the corner portion working tool of Embodiment 1, and an element sectional view of the tool blade portion in Embodiment 1;

FIG. 9A is an element overview diagram showing the tool and the deburring state for illustrating working with the corner portion working tool of Embodiment 3, and a perspective view of a tool blade portion in Embodiment 3;

FIG. 9B is an element overview diagram showing the tool and the deburring state for illustrating working with the corner portion working tool of Embodiment 3, and an element sectional view of the tool blade portion;

FIG. 10A is a perspective view of a machine element component for illustrating working with a corner portion working tool of Embodiment 4, and shows a state of the machine element component with a groove formed in an outer periphery;

FIG. 10B is an element sectional view showing the machine element component, a tool, and a deburring state for illustrating working with the corner portion working tool of Embodiment 4, and shows a state during working;

FIG. 11A is an element sectional view for illustrating working with the corner portion working tool of Embodiment 4, and shows a state immediately before corner portion forming; and

FIG. 11B is an element sectional view for illustrating working with the corner portion working tool of Embodiment 4, and shows a state immediately after corner portion forming.

### DETAILED DESCRIPTION OF THE PREFERRED EMBODIMENTS

Now, specific embodiments of the present invention will be described in detail with reference to the drawings. In the drawings referred to in the following description, components having the same function are denoted by the same reference numerals, and overlapping descriptions are omitted as much as possible.

### Embodiment 1

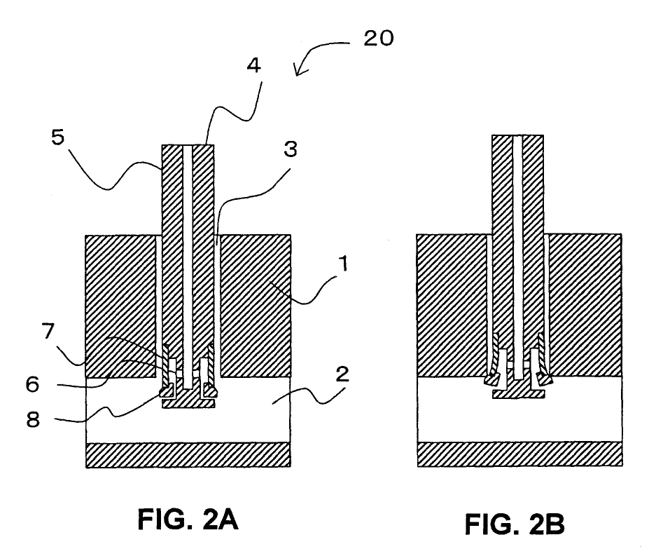

FIGS. 2A and 2B are element sectional views for illustrating Embodiment 1 for deburring and corner portion shape forming of crossing holes according to the present invention. FIG. 2A is an element sectional view for illustrating a state where for a material 1 having crossing holes of a first hole 2 and a second hole 3 previously formed by a drilling tool, a corner portion working tool (tool 20) according to the present invention mounted to a spindle of a machining device is moved into the hole 3 by an automatic moving mechanism of the machining device. FIG. 2B is an element sectional view for illustrating a state where the spindle of the machining device is rotated to remove a burr and form a corner portion shape at an outlet of the hole 3.

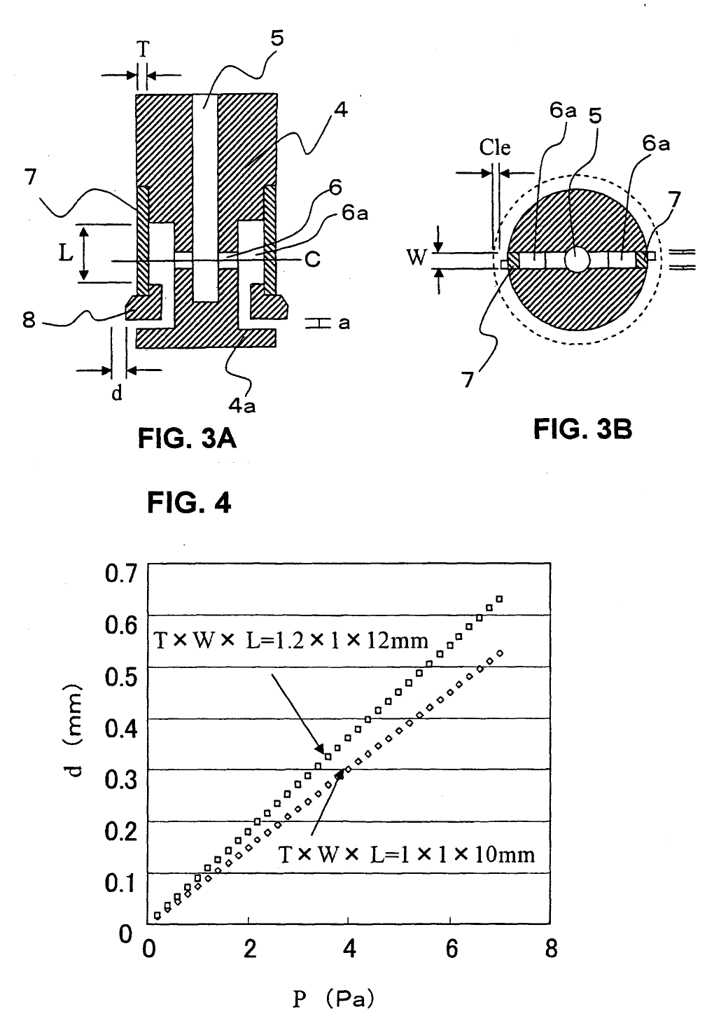

First, with reference to FIG. 2A, a structure of the tool 20 according to Embodiment 1 will be described. The tool 20 includes a tool main body portion 4, a tool blade edge support portion 7, and a tool blade portion 8. An upper portion of the tool main body portion 4 has a circular shape for easy mounting to the spindle (rotating shaft) of the machining device. In an axial center of the tool main body portion 4, a hole 5 is drilled to the tip (lower portion in the drawing) of the tool so that a cutting fluid for cooling and lubricating a cut portion during cutting, which is kept in a general machining device, can pass through the hole 5. The hole 5 has a passing hole 6 in a diameter direction in the tip of the tool main body portion 4, and has a structure in which the cutting fluid is discharged to the outside through the tool blade edge support portion 7 partially joined to an outer periphery of the tool main body portion 4 and the tool blade portion 8 joined to the tool blade edge support portion 7. Near an outlet of the passing hole 6, an outlet space 6a is provided on an inside of the tool blade edge support portion 7 and the tool blade portion 8 as shown in FIGS. 3A and 3B.

One end of the tool blade edge support portion 7 is joined to the tool main body portion 4 in an upper position than the outlet space 6a, for example, by brazing, screwing, or the like, and the other end of the tool blade edge support portion 7 is joined to the tool blade portion 8 by brazing or the like. A bottom 4a of the tool main body portion 4 is formed below the tool blade portion 8. The tool main body portion 4 is made of tool steel, and the tool blade edge support portion 7 is made of a material suitable for elastic deformation, for example, spring steel. The deformable tool blade portion 8 is made of a material suitable for working, for example, cemented carbide. A tip of an outer peripheral portion of the tool blade portion 8 has a blade edge shape required for deburring and corner portion forming. A diameter of the tool 20 is 0.1 mm smaller than the hole 3, including a protrusion on the outer peripheral portion of the tool blade portion 8.

Then, operations of deburring and corner portion shape forming will be described with reference to FIGS. 2A and 2B. FIG. 2A shows a state where the tip of the tool 20 is moved to a lower position than a corner portion formed at a crossing portion of the hole 3 and the hole 2 by the automatic moving mechanism of the machining device. In this state, the cutting fluid is automatically supplied from the spindle of the machining device. The cutting fluid is discharged to the outside of the tool through the tool blade edge support portion 7 and the tool blade portion 8 of the tool 20. At this time, gaps a and b between the tool main body portion 4 and the tool blade edge support portion 7 and the tool blade portion 8 are small, for example, about 0.02 mm or less, and thus in the outlet space (back side of the tool blade portion 8) 6a of the passing hole 6 of the tool blade edge support portion 7, cutting fluid pressure maintains substantially the same hydrostatic pressure as cutting fluid supply pressure of the machining device. Thus, the pressure causes bending deformation of the tool blade edge support portion 7 toward the outer peripheral portion in the diameter direction. Thus, the tool blade portion 8 joined to the tool blade edge support portion 7 is also displaced toward the outer peripheral portion in the diameter direction. After such a state, the spindle of the machining device is rotated, the tool 20 is elevated from the side of the hole 2 by the automatic moving mechanism of the machining device, the tool blade portion 8 is moved to the crossing portion of the hole 2 and the hole 3 to perform deburring or corner portion shape forming at the crossing portion. FIG. 2B shows a state where deburring and corner portion shape forming in the crossing holes are simultaneously performed by the above-described operation. When the supply pressure of the cutting fluid is reduced, the tool blade portion 8 is returned to the inside by an elastic force of the tool blade edge support portion 7.

Next, a setting method of an amount of movement of the tool blade portion 8 in the diameter direction and an amount of corner portion shape forming in the crossing holes will be described. FIG. 3A is an element sectional view showing details of the tip of the tool 20. FIG. 3B is an element sectional view of a part C in the element sectional view in FIG. 3A viewed from an upper side in an axial direction. The amount of corner portion shape forming in use of the tool according to the present invention can be determined by a size of the tool blade edge support portion 7, an amount of gap between the tool blade portion 8 and the hole 3, and supply pressure of the cutting fluid. When a member thickness of the tool blade edge support portion 7 is T and a member length is L as shown in FIG. 3A, and a member width of the tool blade edge support portion 7 is W as shown in FIG. 3B, radial displacement d of the tool blade portion 8 in FIG. 3A is proportional to the supply pressure P of the cutting fluid. The circular shape shown by the dotted line in FIG. 3B shows an inner diameter of the hole 3, and a difference from a radius of the tool blade portion 8, that is, the gap is Cle for description.

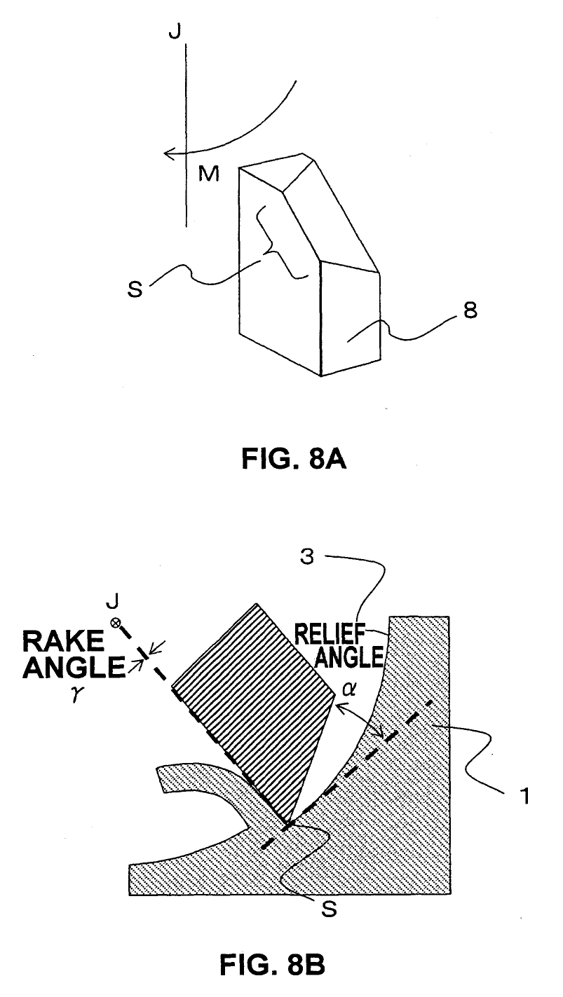

As shown in FIG. 8A, a cutting edge portion of the tool blade portion 8 is formed of a surface parallel to an axial direction J of the second hole 3, that is, a surface perpendicular to a rotational direction M, this surface has a side inclined at 45° to the axial direction J on an outer peripheral side, and this side forms a cutting edge portion S that performs deburring and corner portion forming. FIG. 8B is an element sectional view of the cutting edge portion S viewed perpendicularly from the axial direction J in FIG. 8A, showing a state where the cutting edge portion S performs deburring and corner portion forming at the corner portion of the second hole 3. A rake angle γ required for deburring and corner portion forming is 0° which is the same angle as the surface perpendicular to the axial direction J, and a relief angle is 11°.The cutting edge portion S is rotated in the rotational direction M and advanced, and cuts in the corner portion by the displacement d to remove the burr at the corner portion, and the cutting edge portion S is at 45° to the axial direction J, and thus a corner portion shape of 45° can be formed at the corner portion of the second hole 3.

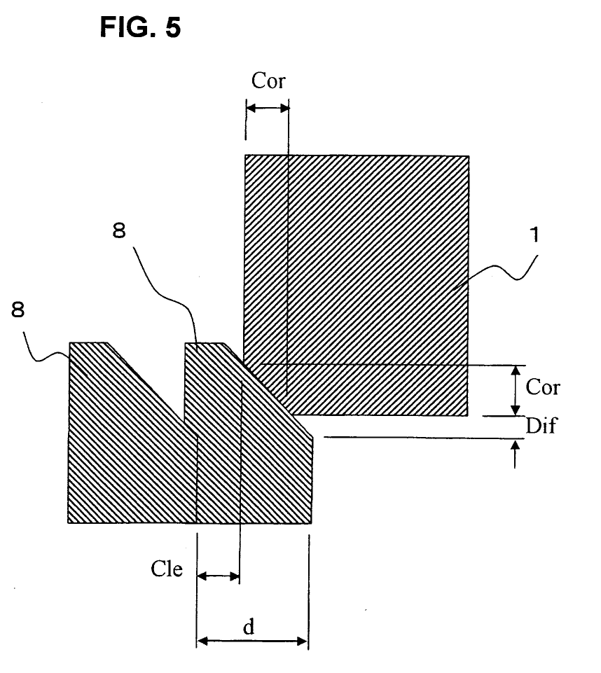

FIG. 4 is a graph showing a relationship between the radial displacement d of the tool blade portion 8 and the supply pressure P of the cutting fluid, which is previously calculated for each type of tool blade portion 8 by experiment, and means that the displacement d increases the diameter of the tool blade portion 8. In the present invention, the member thickness T of the tool blade edge support portion 7 is 1 mm, the member width W is 1 mm, and the member length L is 10 mm, but an example is also shown with the member thickness T of 1.2 mm, the member width W of 1 mm, and the member length L of 12 mm for reference. As shown in FIG. 4, the relationship between the radial displacement d of the tool blade portion 8 and the supply pressure P of the cutting fluid is linear, and determining the supply pressure P of the cutting fluid allows the radial displacement d of the tool blade portion 8 to be calculated using FIG. 4.

Next, with the displacement d thus calculated, a setting method of an amount of corner portion shape forming will be described using FIG. 5. FIG. 5 is an element sectional view showing a relative relationship between the tip portion of the tool blade portion 8 provided at the tip of the tool 20 of the present invention and the hole 3. A case where a corner portion at the crossing portion of the hole 3 and the hole 2 is chamfered at 45° with a width of Cor×Cor, and a corner portion shape of Cor×Cor is formed will be described.

In this case, the NC machining device selects an optimum tool blade portion 8 according to the diameter of the hole 3 and chamfering at 45°. In this case, a difference between a height position of the cutting edge portion contributing to cutting by the tool blade portion 8 and a height position of the corner portion where the corner portion is to be formed is Dif, a radial gap from the hole 3 is Cle, the radial displacement of the tool blade portion 8 is d, and thus Cor can be calculated from a geometric relationship. Specifically, Cor can be calculated by subtracting a value of addition of the difference Dif between the height position of the corner portion and the cutting edge position and the radial gap Cle from the radial displacement d of the tool blade portion 8. The displacement d is in the linear relationship with the supply pressure P of the cutting oil as described in FIG. 4, and thus finally, the corner portion shape Cor×Cor can be automatically determined from the relationship between the amount of radial displacement of the selected tool blade portion 8 and the supply pressure P of the cutting fluid previously calculated as described above.

The supply pressure P is adjusted, and thus when the supply pressure P is a certain value or less, only deburring at the corner portion is performed, and the displacement d increases with increasing supply pressure P to increase an amount of chamfering, thereby allowing deburring and corner portion shape forming to be simultaneously performed.

There is a possibility that a flow rate of the cutting fluid supplied through the passing hole 6 and the outlet space 6a increases to cause pressure loss that locally reduces pressure required for the displacement d at the same time as the increase in the supply pressure P increases the displacement d. However, a space volume of the outlet space 6a is set to be larger than a volume of a gap portion between the tool blade edge support portion 7 and the tool blade portion 8, and the tool main body portion 4, and thus the supply pressure is not reduced, and an output of the displacement proportional to the supply pressure can be obtained.

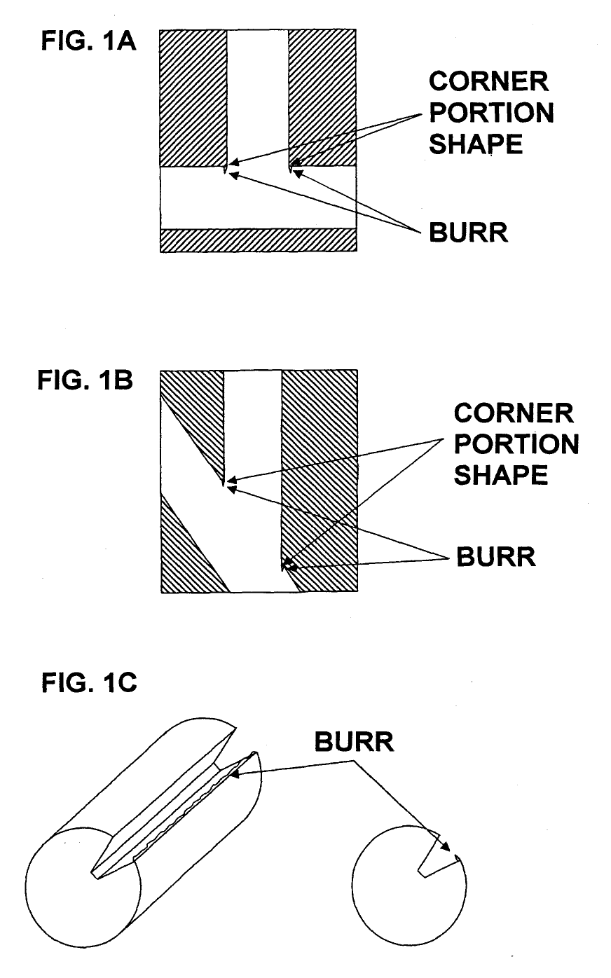

With the tool thus configured and the above-described method, only vertical movement and rotation of the machining device and the supply pressure of the cutting fluid allows removal of a burr formed at the corner portion of the crossing hole and also forming an arbitrary corner portion shape in the aspect shown in FIG. 1A, and the shape of the corner portion can be controlled by the supply pressure of the cutting fluid. In the present invention, the tool blade portion 8 is expanded according to the supply pressure of the cutting fluid and is not substantially influenced by a centrifugal force, and thus there is no need for a spindle mechanism that rotates at high speed as in the conventional technique in which a brush, a wire, or the like is expanded by a centrifugal force by rotation of a spindle of a machining device to work a corner portion. Also, the amount of corner portion shape forming does not depend on a rotational speed of the spindle but can be determined by the supply pressure of the cutting fluid, and thus there is no need for a time for considering through trial and error various conditions such as a rotational speed of the spindle for an arbitrary corner portion shape by experiment. There is no need for rotation at high speed, and little heat is generated during working, thereby reducing remaining stress at the corner portion to prevent deformation of the corner portion. In the present invention, the two tool blade portions 8 of the tool 20 are provided in the diameter direction, but the same effect can be obtained with one tool blade portion. In the present invention, a necessary amount of cutting fluid is directly supplied to a cut portion, thereby also reducing cutting temperature of the cut portion to increase lubricity.

### Embodiment 2

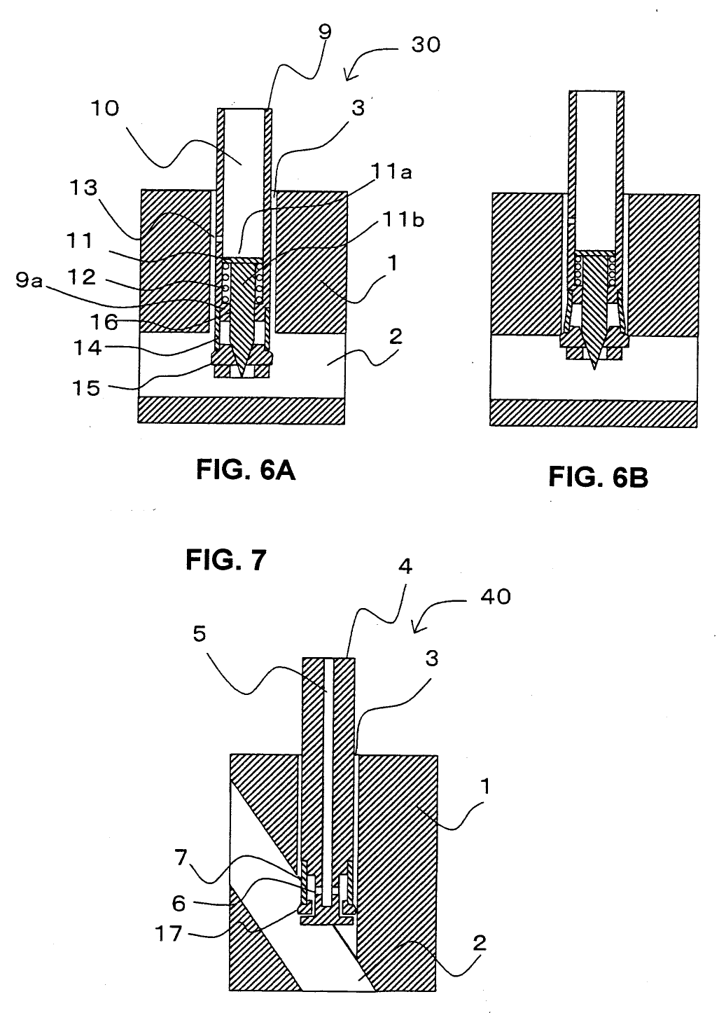

FIG. 6 is an element sectional view for illustrating different Embodiment 2 for deburring and corner portion shape forming of crossing holes according to the present invention. FIG. 6A is an element sectional view for illustrating a state where for a material 1 having crossing holes of a first hole 2 and a second hole 3 previously formed by a drilling tool, a tool 30 according to the present invention mounted to a spindle of a machining device is moved into the hole 3 by an automatic moving mechanism of the machining device. Also, FIG. 6B is an element sectional view for illustrating a state where the spindle of the machining device is rotated to remove a burr at a corner portion and form a corner portion shape of an outlet of the hole 3.

First, with reference to FIG. 6A, a structure of the tool 30 according to the present invention will be described. The tool 30 includes a tool main body portion 9, a push rod 11, a spring 12, a tool blade edge support portion 14, and a tool blade portion 15. An upper portion of the tool main body portion 9 has a circular shape for easy mounting to the spindle (rotating shaft) of the machining device. In an axial center of the tool main body portion 9, a hole 10 is drilled to the tip (lower portion in the drawing) of the tool so that a cutting fluid kept in a general machining device can passes through the hole 10. The push rod 11 is provided in the hole 10, which has a circular flange 11a with substantially the same outer size as an inner diameter of the hole 10 and can be moved in the axial direction of the hole 10 by pressure of the cutting fluid. A lower portion 11b of the flange of the rod 11 has a plate shaped section, and the tip 11c (lower portion in the drawing) has a triangular shape. A guide hole 16 having substantially the same shape as the plate shape of the portion is provided in a bottom of the hole 10, and forms a guide shape for easy vertical movement of the rod 11. A spring 12 is provided between the flange 11a of the rod 11 and the bottom 9a of the hole 10. A radial passing hole 13 is provided in a middle outer peripheral portion in the axial direction of the tool main body portion 10. The tool blade portion 15 is joined to the tool main body portion 9 via the tool blade edge support portion 14, the triangular tip 11c of the rod 11 is lowered to push a back surface of the tool blade portion 15 from inside and outwardly displace the tool blade portion 15. When the triangular tip 11c of the rod 11 is elevated, the tool blade portion 15 is returned to the inside position by an elastic property of the tool blade edge support portion 14. As shown in FIG. 3B, the tool blade portion 15 can be guided in a groove and stably displaced.

The lower portion 11b of the flange of the rod 11 may be a cylindrical shape, and the tip 11c may be a conical shape.

With such a structure, when the machining device starts supplying the pressure of the cutting fluid, the rod 11 is moved downwardly by a force generated by the supply pressure of the cutting fluid, and when the machining device stops supplying the pressure of the cutting fluid, the cutting fluid is discharged outwardly through the passing hole 13 from the hole 10. Also, a restoring force of the spring 12 acts upwardly, and the rod 11 can be moved upwardly.

A mechanism of a blade portion for deburring and corner portion shape forming of the tool 30 in Embodiment 2 is the same as in Embodiment 1. Specifically, the tool blade edge support portion 14 partially joined to a tip outer periphery of the tool main body portion 9 and the tool blade portion 15 joined to the tool blade edge support portion 14 are provided, and cutting fluid supply pressure of the machining device is applied to move the rod 11 downwardly and displace the tool blade portion 15 in an outer peripheral direction, allowing deburring and corner portion shape forming to be simultaneously performed. FIG. 6B shows a state where, from the state in FIG. 6A, the cutting fluid supply pressure of the machining device and the rotation of the spindle are provided to elevate the tool 30 to the crossing portion of the hole 2 and the hole 3, removal of a burr formed at the crossing portion of the and hole 2 and the hole 3 and corner portion shape forming are simultaneously performed. As in Embodiment 1, a relationship between an amount of displacement of the tool blade portion 15 in the outer peripheral direction selected according to a diameter and an angle shape of the hole 2 and the cutting fluid supply pressure is previously calculated for each type of tool blade portion 15, and the cutting fluid supply pressure is adjusted to allow only deburring of the corner portion, or adjusting an amount of chamfering performed simultaneously with the deburring.

At this time, the cutting fluid required for deburring or corner portion shape forming is supplied through the radial passing hole 13, an amount of supply increases with increasing cutting fluid supply pressure to ensure the cutting fluid required for working, and when the cutting fluid supply pressure is reduced after the working is finished, cutting fluid pressure is relieved through the passing hole 13 to elevate the rod 11 with good response to retract the blade portion.

With the tool thus configured and the above-described method, only vertical movement and rotation of the machining device and the supply pressure of the cutting fluid allows removal of a burr formed at the corner portion of the crossing holes and also forming an arbitrary corner portion shape, and the shape of the corner portion can be controlled by the supply pressure of the cutting fluid. Thus, there is no need for a spindle mechanism that rotates at high speed in the machining device. Also, the amount of corner portion shape forming does not depend on a rotational speed of the spindle, and thus there is no need for a time for considering through trial and error an arbitrary corner portion shape by experiment. In the present invention, the two tool blade portions 15 of the tool 30 are provided in the diameter direction, but the same effect can be obtained with one tool blade portion.

### Embodiment 3

FIG. 7 is an element sectional view for illustrating different Embodiment 3 for deburring and corner portion shape forming of crossing holes according to the present invention. FIG. 7 is an element sectional view for illustrating a state where for a material 1 having crossing holes of a first hole 2 and a second hole 3 previously formed by a drilling tool, a tool 40 according to the present invention mounted to a spindle of a machining device is moved into the hole 3 by an automatic moving mechanism of the machining device.

The tool 40 according to Embodiment 3 has the same structure as the tool 20 described in Embodiment 1, but the first hole and the second hole diagonally cross each other, and a tool blade portion 17 is provided to address a different relative position between the tool blade portion and a burr.

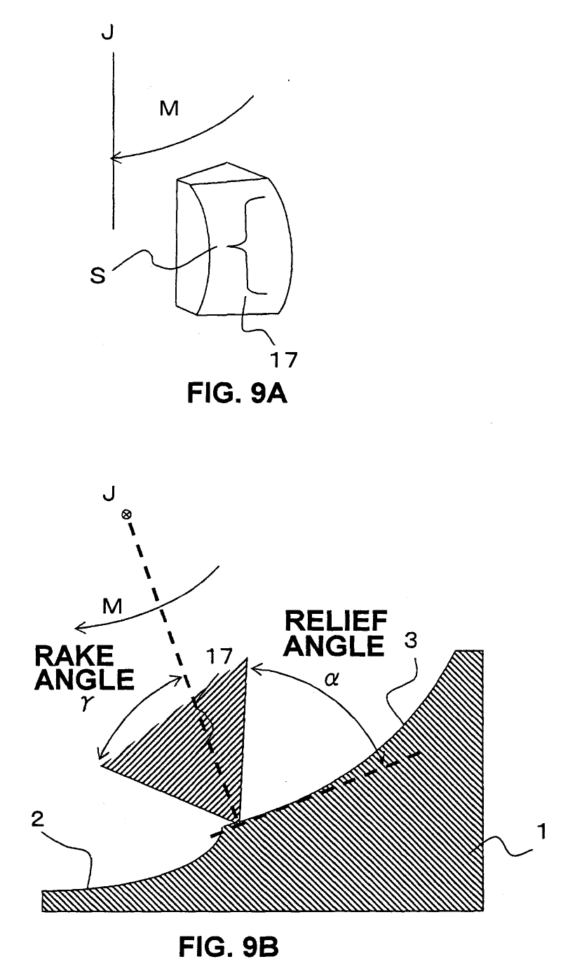

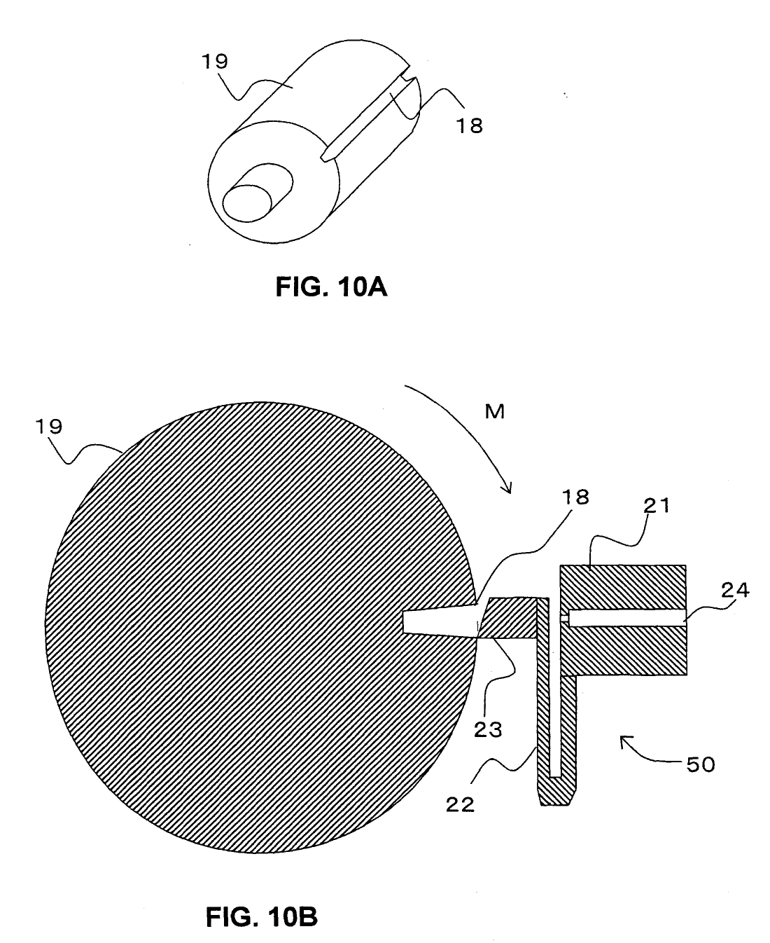

FIG. 8A is a perspective view of the tool blade portion 8 used in Embodiment 1. FIG. 9A is a perspective view of the tool blade portion 17 used in Embodiment 3. FIG. 9B is an element sectional view showing a state where a corner portion in the diagonally crossing portion in Embodiment 3 is worked by the tool blade portion 17.

For the tool blade portion 8 in Embodiment 1 shown in FIG. 8A, the first hole 2 and the second hole 3 perpendicularly cross each other as shown in Embodiment 1, and thus the cutting edge portion S of the tool cutting edge 8 for deburring and corner portion forming is formed of a surface parallel to the axial direction of the first hole 2, that is, a surface perpendicular to the rotational direction M. For the corner portion shape in Embodiment 1, the cutting edge portion S is inclined at 45° to the axial direction of the first hole to form a corner portion with an angle of 45°.

However, in Embodiment 3, the first hole 2 and the second hole 3 diagonally cross each other, and thus a cutting edge portion S of the tool blade portion 17 shown in FIG. 9A has a curved shape, and the cutting edge portion S is at an obtuse angle to the rotational direction M, and is at −45° in this Embodiment. Further, a rear portion of the cutting edge portion, that is, a relief surface has a relief angle of 60° to the rotational direction M.

The tool 40 having the tool cutting edge 17 thus configured can be moved perpendicularly to the rotational direction M of the tool by the supply pressure of the cutting fluid in the diameter direction of the first hole at the corner portion of the first hole 2 and the second hole 3 as shown in a section during working in FIG. 9B, thereby allowing burring and corner portion forming. The relief angle is 60°, and thus the relief surface does not interfere with the corner portion, thereby allowing a sharp corner portion to be formed. A corner portion of 45° can be formed when a relief angle is 45° or more.

As in Embodiments 1 and 2, the relationship between the amount of movement of the tool perpendicular to the rotational direction M and the cutting fluid supply pressure is previously calculated for each type of tool by experiment, and cutting fluid supply pressure is automatically selected according to the selected tool.

As shown in FIG. 9A, the cutting edge portion of the tool blade portion 8 is formed in a surface parallel to the axial direction J of the second hole 3, that is, a surface perpendicular to the rotational direction M, this surface has a curved side with respect to the axial direction J on an outer peripheral side, and this side forms a cutting edge portion S that performs deburring and corner portion forming. FIG. 9B is an element sectional view showing a section of the cutting edge portion S in FIG. 9A in a direction of the normal, showing a state where the cutting edge portion S performs deburring and corner portion forming at the end of the second hole 3. A rake angle γ required for deburring and corner portion forming is −45° to the surface perpendicular to the axial direction J, and a relief angle is +60° with reference to a tangential direction of the axial direction J. The cutting edge portion S is rotated in the rotational direction M and advanced, and is displaced in an outer peripheral direction and thus radially cuts in the corner portion to remove the burr at the corner portion, and the cutting edge portion S forms a curved surface with respect to the axial direction J, and thus a corner portion shape of 45° or more can be formed at the corner portion of the second hole 3 in the rotational direction M.

### Embodiment 4

FIG. 10A shows a machine element component 19 of a shaft structure having a groove 18 parallel to an axis in an outer peripheral portion used as a spline shaft and a slide key. In the machine element component having such a groove, both when a rotating tool is used to work the groove 18 and then the outer peripheral portion of the shaft is worked by turning, and when the outer peripheral portion is worked by turning and then the groove 18 is worked by rotating, a burr is formed at the corner portion of the groove 18. For the burr, deburring and corner portion forming can be performed by the above-described conventional method, but when the groove is very long, or a plurality of grooves 18 are formed around the shaft, a working time for deburring and corner portion forming is increased.

FIG. 10B is a sectional view of an embodiment according to the present invention that can perform deburring and corner portion forming when the groove is formed in the outer peripheral portion of the shaft. A tool 50 in FIG. 10B includes a tool main body portion 21, a tool blade edge support portion 22 that can be elastically deformed, and a tool blade portion 23, and the tool main body portion 21 has a rectangular shape for mounting to a blade securing base of the machining device. The tool main body portion 21 has a hole 24 drilled to the tip (left portion in the drawing) of the tool so that a cutting fluid for cooling and lubricating during cutting, which is kept in a general machining device, passes through the hole 24, collides with a back surface of the tool blade edge support portion 22, and then is supplied to a contact portion between the tool blade portion 23 and the groove. The tip of the tool main body portion 21 is joined to the tool blade edge support portion 22, the tool blade edge support portion has a U shape so as to easily cause elastic deformation, and the tool blade portion 23 is secured to the tip. The tool blade portion 23 sets a rake angle to −60° and a relief angle to 90° to the rotational direction M of the machine element component 19.

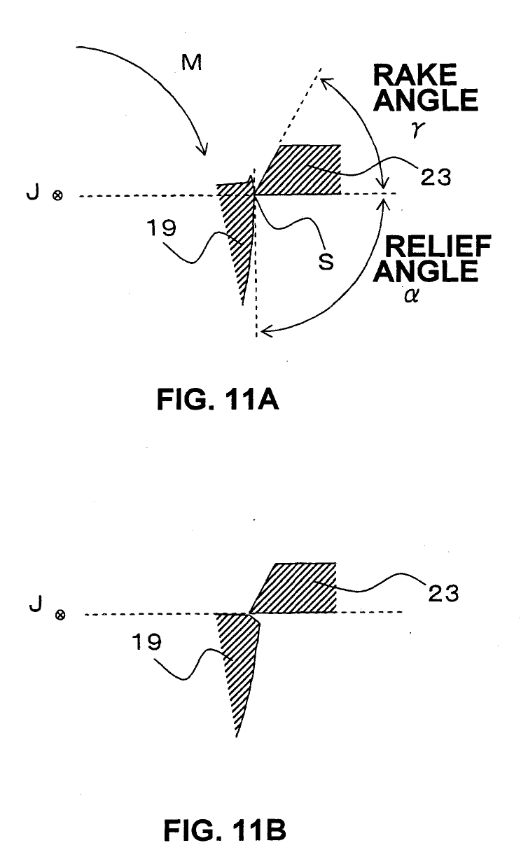

As shown in FIG. 11A, the cutting edge portion of the tool blade portion 23 is formed in a surface parallel to the axial direction J of the machine element component 19, that is, a surface perpendicular to the rotational direction M, this surface has a curved side with respect to the axial direction J on an outer peripheral side, and this side forms a cutting edge portion S that performs deburring and corner portion forming. FIGS. 11B and 11C are element sectional views showing a section of the cutting edge portion S in FIG. 10A in a direction of the normal, showing a state where the cutting edge portion S performs deburring and corner portion forming of the machine element component 19. As shown in FIG. 11A, a rake angle γ required for deburring and corner portion forming is −60° to the surface perpendicular to the axial direction J, and a relief angle is +90° with reference to a tangential direction of the axial direction J. Then, as shown in FIG. 11B, the machine element component 19 is rotated in the rotational direction M to relatively advance the cutting edge portion S, and the cutting edge portion S is displaced in the axial direction and thus radially cuts in the corner portion to remove the burr at the corner portion, and the cutting edge portion S forms a curved surface with respect to the axial direction J, and thus a corner portion shape of 45° or more can be formed at the groove of the machine element component 19 in the rotational direction M.

With the tool 50 thus configured, the machine element component 19 is rotated and then pressure of the cutting fluid is applied to the hole 24 of the tool 50, thus the tool blade edge support portion 22 is elastically deformed with increasing cutting fluid pressure that collides with the back surface of the tool blade edge support portion 22, and the tool blade portion 23 can enter the corner portion of the groove 18 to remove a burr and simultaneously form a corner portion. Then, a relief surface of the tool blade portion 23 comes into contact with the facing corner portion, but the relief angle of the tool blade portion 23 is large, and thus corner portion forming is not performed. Thus, as in general turning, the machine element component 19 is simply rotated and the tool is moved in the axial direction of the machine element component to allow deburring and corner portion shape forming at the corner portion to be efficiently performed. For the facing corner portion shape forming, the tool 50 is turned upside down to work the machine element component 19 in the same manner, thereby obtaining a corner portion shape. To prevent a change in a working surface by the rake surface coming into contact with the outer peripheral surface of the machine element component 19, a rotation position of the groove 18 of the machine element component 19 is previously recognized by the machining device, and pressure of the cutting fluid is applied or removed in synchronization with passage of the tool blade portion 23 through the groove 18, thereby preventing a change in surface roughness by contact of the rake surface.

In the hydraulic circuit component of the mechanism element component produced in the present invention, there is no burr in the crossing portion or the groove in the hole, and an appropriate corner portion is formed. Thus, the hydraulic circuit component can be used in a motor in which no trouble occurs due to falling of a burr and a corner portion among motors or the like using a hydraulic circuit. Also, for example, a shaft mechanism component that transmits torque, whose relative position needs to be determined by a round pin and a hole portion, can be used in a shaft mechanism in which no trouble occurs such as breakage or cracks due to stress concentration on a corner portion because of proper shape forming of the hole corner portion.

Also a plurality of working tools having a blade shape as shown in Embodiment 1, 2, 3 and 4 are prepared, and a machining device such as an NC machining device automatically selects an optimum working tool depending on shapes of a hole or a groove to be formed, further burr formation states, and corner portion shapes to be formed, and automatically selects optimum cutting fluid supply pressure for the selected working tool, thereby allowing total automation of deburring and corner portion forming.

What is claimed is:

1. A corner portion working tool comprising:
a main body portion having a space through which a cutting fluid can pass; and
a blade portion that is provided in the main body portion and can be displaced outwardly of the main body portion,
wherein the blade portion is displaced outwardly of the main body portion according to a change in hydrostatic pressure of the cutting fluid having passed through the space, and the main body portion is rotated to work a corner portion with the blade portion.

2. The corner portion working tool according to claim 1, wherein the blade portion is mounted to the main body portion via an elastic member, and with increasing hydrostatic pressure of the cutting fluid, the blade portion is displaced outwardly of the main body portion against an elastic force of the elastic member.

3. The corner portion working tool according to claim 1, wherein a relationship between hydrostatic pressure of the cutting fluid and an amount of outward displacement of the blade portion is previously calculated by experiment for each type of corner portion working tool, and the selected hydrostatic pressure of the cutting fluid is supplied to the space in the main body portion so as to obtain a necessary amount of outward displacement in working the corner portion.

4. The corner portion working tool according to claim 1, wherein a cutting blade of the blade portion is perpendicular to a rotational direction, has a surface with a side inclined to an axial direction on an outer peripheral side, and the cutting blade works the corner portion.

5. The corner portion working tool according to claim 1, wherein the cutting blade of the blade portion is at an obtuse angle to the rotational direction, has a rake angle of −45° to a cutting direction, and has a curved surface with a relief angle of +45° or more, and the cutting blade works the corner portion.
